(19) United States
(12) Patent Application Publication
(10) Pub. No.: US 2004/0205722 A1
(43) Pub. Date: Oct. 14, 2004

(54) Software quality control system and method for controlling software quality

(75) Inventor: Hiroshi Shimada, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 09/944,415

(22) Filed: Sep. 4, 2001

(30) Foreign Application Priority Data
Sep. 5, 2000 (JP) 2000-269253

(51) Int. Cl. G06F 9/44; H04L 1/22

(52) U.S. Cl. 717/124; 714/38

(57) ABSTRACT

A software quality control system has a control terminal provided to an administrator, information terminals provide at each work location, an information processor, a storage apparatus for storage of data, and the Internet, which connects the infonration terminals and the information processor. The information terminals 4 access the information processor via the Internet, and perform storage of quality data. The information processor stores input quality data in the storage apparatus 3 and, in response to a request from an information terminal, performs such operations as searching and analysis of quality data stored in the storage apparatus.

### BACKGROUND OF THE INVENTION

1. Field of the Invention

The present invention relates to a centralized software quality control system and a method of quality control used for a centralized control of quality control information suitable for use in the control of the quality of jointly developed software in a distributed development environment, by collecting same at a control terminal via the Internet.

2. Related Art

In recent years, with advancements in the development of computer networks, software development is generally migrating to the mode of joint development in a distributed environment. When undertaking joint development in a distributed environment, the overall software system is first designed, followed by division of the system into sub-systems. The development of each of the divided sub-systems is taken on by individual development locations. When the overall system is collected together, after completion of stand-alone testing of the sub-systems designed and developed at each location, these subsystems are collected at the location at which they are to be assembled into the overall system. In the past, to obtain an understanding of the quality of software developed by this type of process, an administrator having overall responsibility periodically, or as the need arose, inquired to each software development location with regard to progress and quality data with regard to the software being developed, and collected the data given in response to these inquiries. Statistics were then taken of this collected data and control was performed based on an analysis thereof.

In a quality control system for software such as described above, however, a great deal of time and labor was required to collect the quality data from the various distributed development locations, making it impossible to shorten the time interval between data collection, thereby making it difficult to gain an appropriate understanding of the overall quality conditions, and delaying corrective measures with respect to problems that arose. Additionally, in a distributed environment in which the development location are physically separated, because the quality conditions at one development location are not related to another location quickly, it is difficult to perform exchange of quality information between locations, making it impossible to prevent the duplication of problems that arise, resulting in great waste in unnecessary work. Because it was not possible to properly understand the quality control conditions in each sub-system, when a quality problem arose at the overall system assembly stage, there was a great influence on the overall software development schedule.

Accordingly, it is an object of the present invention, in consideration of the above-described problems in the related art, to provide a software quality control system and method for software quality control, in which quality data is collected from terminals at each software development location in a distributed environment, and subjected to centralized control at a control terminal, enabling a proper understanding to be quickly achieved with regard to the overall quality conditions, thereby enabling improvement of the overall software quality. It is a further object of the present invention to provide a software quality control system and method for software quality control which enable monitoring of software quality data of one development location from each one of terminals at any time, thereby preventing duplication of problems arising in a distributed environment, and avoiding duplication of effort, so as to enhance the work efficiency.

### SUMMARY OF THE INVENTION

To achieve the above-noted objects, the present invention adopts the following described technical constitution.

Specifically, a first aspect of the present invention is a software quality control system controlling the quality of software jointly developed in a distributed environment, the software quality control system comprising, a control terminal for performing an input of quality data of the developed software and a selection of data processing function, an information terminal having a communication means and for performing an input of quality data of the developed software and a selection of data processing function, for inputting software quality data and selecting data processing function, an information processor for processing data input from information input from the control terminal and the information terminal, a storage apparatus for storing data input from the information processor, and a data communication network that connects the information terminal and the information processor, wherein the information processor performs saving of quality data input from the control terminal and the information terminal, and retrieving or analysis of data stored in the storage apparatus, based on conditions input at the information terminal.

A second aspect of the present invention is a variation on the software quality control system of the first aspect, wherein quality data input from the control terminal and the information terminal is data indicating software quality or data indicating handling situation for a problem to be treated in the software.

3. A third aspect of the present invention is a variation on the software quality control system of either the first or the second aspect, wherein the quality data input from the control terminal and the information terminal is classified in the information processor into either one of items of a system, a joint development working group, key personnel, or control data, and each being stored in the storage apparatus.

A fourth aspect of the present invention is a variation on the software quality control system of any one of the first to third aspects, wherein the quality data input from the control terminal or the information terminal is data with regard to a scheduled test of developed software or with regard to test results.

A fifth aspect of the present invention is a variation on the software quality control system of the first aspect, wherein the information processor stores a processing program in accordance with a type of analysis for quality data, and which, in response to the type of analysis and analysis conditions input from the information terminal, performs analysis of quality data stored in the storage apparatus and outputs the results of the analysis.

A sixth aspect of the present invention is a variation on the software quality control system of any one of the first to fifth aspects, wherein the control terminal and the information terminal comprise web browsers, which are used to perform to input data and to display data supplied from the information processor.

A seventh aspect of the present invention is a variation on the software quality control system of any one of the first to sixth aspects, wherein the data communication network is the Internet.

An eighth aspect of the present invention is a method for controlling the quality of software jointly developed in a distributed environment, this method having a step of, inputting quality data of developed software to a terminal, classifying the quality data input from the terminal via a data communication network by an information processor into pre-established data types, and storing the data in a storage means, retrieving data stored in the storage means an information terminal by the information processor in accordance with a retrieving condition as input from the terminal and displaying the retrieved results on the terminal by the information processor, and analyzing data stored in the storage means by the information processor, in response to a data analysis request input from the terminal, and displaying the analysis results at the information terminal by the information processor.

### BRIEF DESCRIPTION OF THE DRAWINGS

FIG. 1 is a block diagram showing the configuration of an embodiment of the present invention.

FIG. 2 is a drawing showing quality data saved with initialized values.

FIG. 3 is a drawing showing the flow of function selection.

FIG. 4 is a drawing showing the flow of a quality data display function.

FIG. 5 is a drawing showing the flow of quality data saving, updating, and deletion functions.

FIG. 6 is a drawing showing the flow of the quality data searching function.

FIG. 7 is a drawing showing the flow of the quality data analysis function.

FIG. 8 is a drawing showing the flow of problem handling processing.

### DETAILED DESCRIPTION OF THE PREFERRED EMBODIMENTS

Embodiments of the present invention are described in detail below, with references made to relevant accompanying drawings.

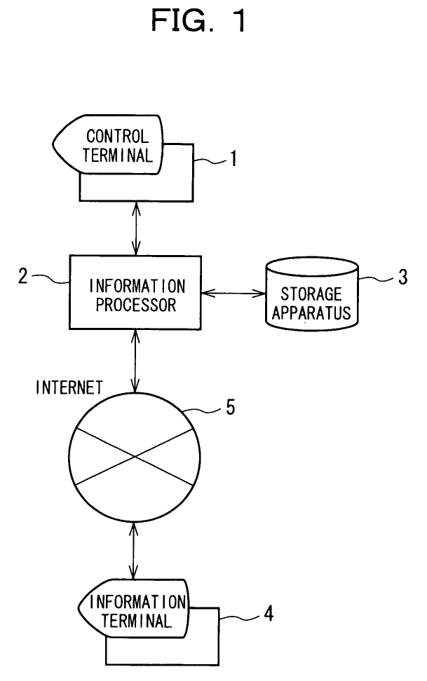

FIG. 1 is a block diagram showing the configuration of a software quality control system according to an embodiment of the present invention, in which drawing the reference numeral 1 denotes a control terminal provided to an administrator, and which is use for input and display of quality data, and 4 is an information terminal provided to each work location performing joint development, which is used to input and display quality data. The control terminal 1 and the information terminal 4 have an input device such as a keyboard or a mouse and a display device such as a CRT display. The reference numeral 2 in FIG. 1 denotes information processor, which performs processing of data input from the control terminal 1 and the information terminal 4, and 3 denotes a storage apparatus which stores data processed by the information processor 2. The information terminal 4 accesses the information processor 2 via the Internet 5, and performs saving and retrieving or like of quality data.

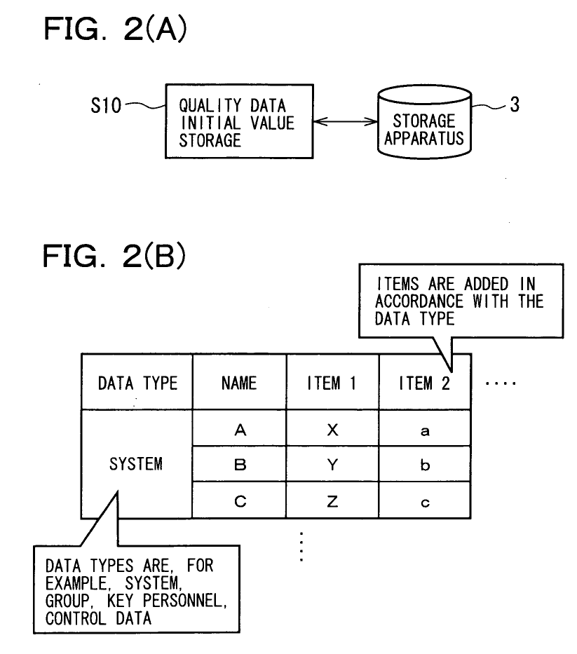

The operation of the software quality control system according to the embodiment as shown in FIG. 1 is described below, with reference to FIG. 1. First, as a preparation step, an initial data of the type of quality data and the quality data itself are registered from the control terminal 1. FIG. 2 shows a processing for saving the initial data of the quality data. At step S10 shown in FIG. 2(A), the control terminal 1 inputs the type of quality data, such as a system, a group, key personnels, and problem detection goals, and the initial data thereof in the storage apparatus.

The information processor 2 saves these data as input from the control terminal 1 into the storage apparatus 3. FIG. 2(B) is a conceptual drawing showing the quality data saved in the storage apparatus 3 classified by the respective type thereof. After the completion of the above-described registration of each one of the initial data, the actual operation of the software quality control system begins.

In order to use the software quality control system from the information terminal 4, the Web browser and the communication program of the information terminal 4 are actuated so as to perform a process of connection to the Internet 5 and thereby enabling the information terminal 4 to access to the information processor 2, which causes the information terminal 4 to display a selection screen for selecting a function to be performed on a display means. At this point, the selection screen for selecting a quality data display function, a quality data storage/update/deletion function, a quality data retrieving function, and a quality data analysis function each being ass function to be performed is displayed.

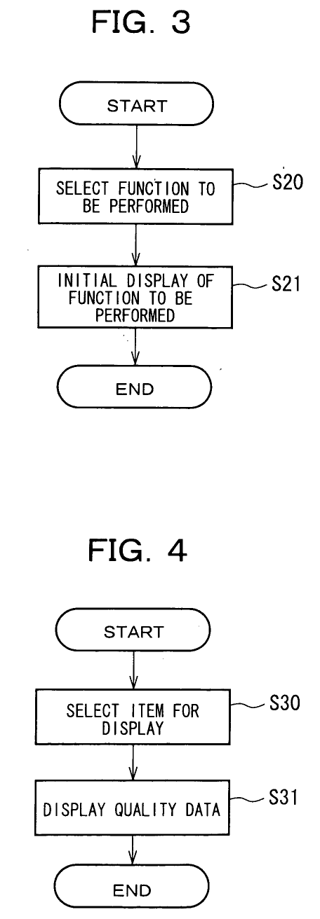

FIG. 3 is a flow-chart showing a sequential process flow of the selection of a function to be performed. At step S20 a request for selection of a function to be performed selected from the function selection screen at the information terminal 4 is sent to the information processor 2 via the Internet 5. The information processor 2, in response to the requested function to be performed, sends information related to initial display for the function to be performed, for example a data input screen, to the information terminal 4, which displays the information received from the information processor 2 (step S21). The flow of processing in the cases in which each one of the functions is selected, respectively, is described below.

First, referring to FIG. 4, a case in which “Quality Data Display Function” is selected will be explained.

First, a request for quality data display input from the information terminal 4 is sent via the Internet 5 to the information processor 2 the information processor 2, in response to the quality data display request, causes the information terminal 4 to display a selection screen for selecting quality data to be. A signal representing a selected quality data to be displayed in accordance with the selection screen, is input from the information terminal 4 (step S30), and it is sent to the information processor 2. The information processor 2, in response to the received selection signal, reads the quality data corresponding to the selection signal thus received, from the storage apparatus 3, and sends this quality data to the information terminal 4 via the Internet 5, whereupon the information terminal 4 displays the received quality data (step S31).

Next, the case in which “Quality Data Save/Update/Delete” function is selected as the function to be performed will be explained.

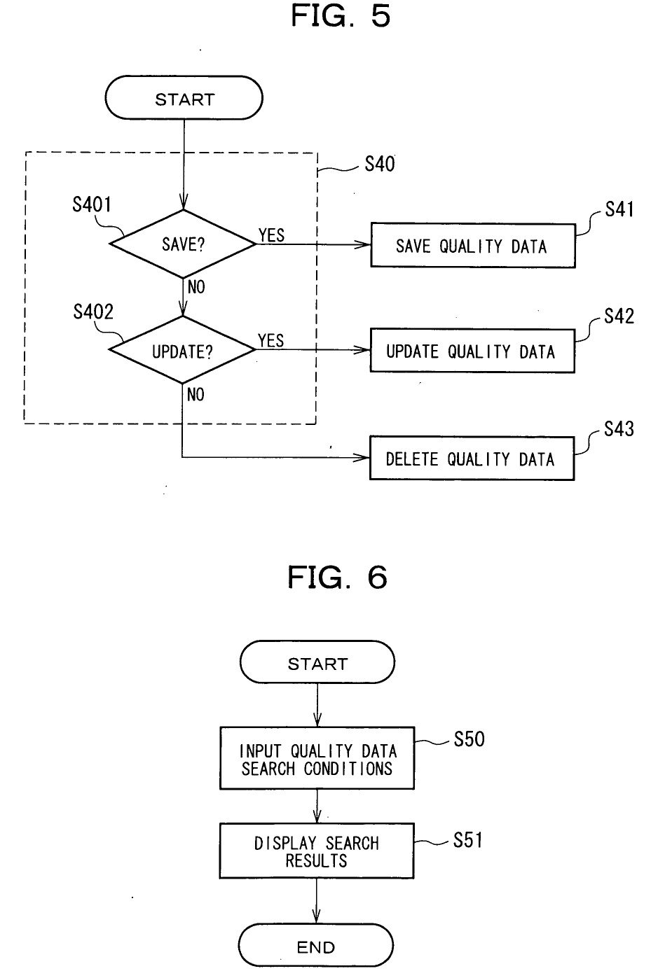

FIG. 5 shows a flow-chart showing a sequential processing for quality data saving, updating, and deleting functions. When a request for processing (for saving/updating/deleting) is sent from the information terminal 4 to the information processor 2 via the Internet 5, at step S40 a determination is made as to the details of the request and, responsive to the type of request, processing proceeds to one of the steps S41 through S43. If the processing request sent to the information processor 2 was “Save”, at step S401 the result of judging the processing request is “Yes” and processing proceeds to step S41. At step S41, the information processor 2, in response to the processing request, causes the information terminal 4 to display the data saving input screen. The quality data input at the data saving input screen is sent to the information processor 2, which saves the input quality data thus input thereto, into the storage apparatus 3, and sends the results of the saving operation to the information terminal 4.

In the case in which the requested processing input from the information terminal 41 was “Update”, at step S401, the result of the judging the processing request is “No” and processing proceeds to step S402, at which a judgment is made that the processing request was for updating, whereupon the processing is proceeded to step S42. At step S42, the information processor 2 causes the information terminal 4 to display a screen for input of the data type, name or the like of the quality data to be updated. The data input in accordance with the input screen, is sent to the information processor 2. The information processor 2, based on the type, name or the like of the input quality data, reads the quality data to be updated and registered in the storage means3, and displays the quality data to be updated, on the information terminal 4. The user of the information terminal 4 verifies the displayed quality data, and inputs updated data. The information processor 2 updates the data stored in the storage apparatus 3 in accordance with the input updated data, and sends the updating results to the information terminal 4.

In the case in which the processing request input from the information terminal 4 was “Delete”, the judgment result at the step S401 is “No”, and processing step is proceeded to step 402, at which the judgment result is again “No”, whereupon processing step is proceeded to step S43. At step 543, the information processor 2 causes the information terminal 4 to display an input screen for inputting the data type, name or the like of the quality data to be deleted thereunto. The information processor 2, based on the input type and name of the quality data to be deleted, as inputted through the input screen, reads the quality data to be deleted, which is stored in the storage apparatus 3, and causes the data to be displayed on the information terminal 4. The user of the information terminal 4 verities the displayed quality data, and inputs an instruction to delete the data into the terminal 4. The information processor 2 deletes the corresponding data stored in the storage apparatus 3 therefrom, in accordance with the input instruction to delete thereof, and notifies the information terminal 4 of the deletion.

Referring to FIG. 6, the flow of processing in the case in which the “Quality Data Retrieval” function is selected at the function selection screen will be explained. When a signal that selects “Quality Data Retrieval” function is sent from the information terminal 4 to the information processor 2, the information processor 2 causes the information terminal 4 to display a screen for inputting the retrieving conditions. At step S50, quality data retrieving conditions are input in accordance with the input screen, and sent to the information processor 2. The information processor 2, based on the quality data retrieving conditions, performs to retrieve quality data stored in the storage apparatus 3, and reads out quality data comply with these conditions, and sends the corresponding data to the information terminal 4. The information terminal 4 displays the retrieving results received from the information processor 2 (step 51).

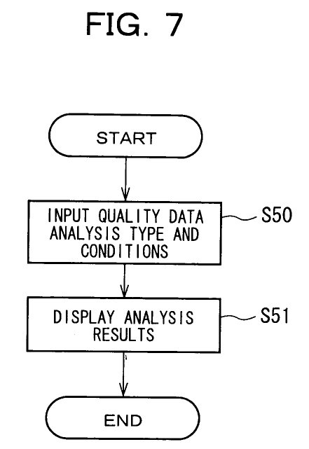

FIG. 7 shows the flow of processing for the case in which “Quality Data Analysis” function is selected at the performing function selection screen. When this function is selected, the information processor 2 causes the information terminal 4 to display an input screen for inputting the type for quality data and conditions for performing the analysis. At step S60, in accordance with the input screen, the type of the quality data and analysis conditions are input from the information terminal 4] and sent to the information processor 2. The information processor 2, based on the input quality data type and input analysis conditions, extracts required quality data from the storage apparatus 3, and analyzes the data, and then sends the results thereof to the information terminal 4, which receives the analysis results from the information processor 2 and displays these results (step S61).

It should be understood that, although the above-described embodiment shows a case in which data being controlled by the software quality control system is quality control data of a software, the present invention is not restricted to the control of quality data, but can also be applied to a control of data related to data for problems processing of a software, a test schedule and the test results of the software, data of review schedule and actual performance results for designing a software or data with regard to construction information of constituent elements of software.

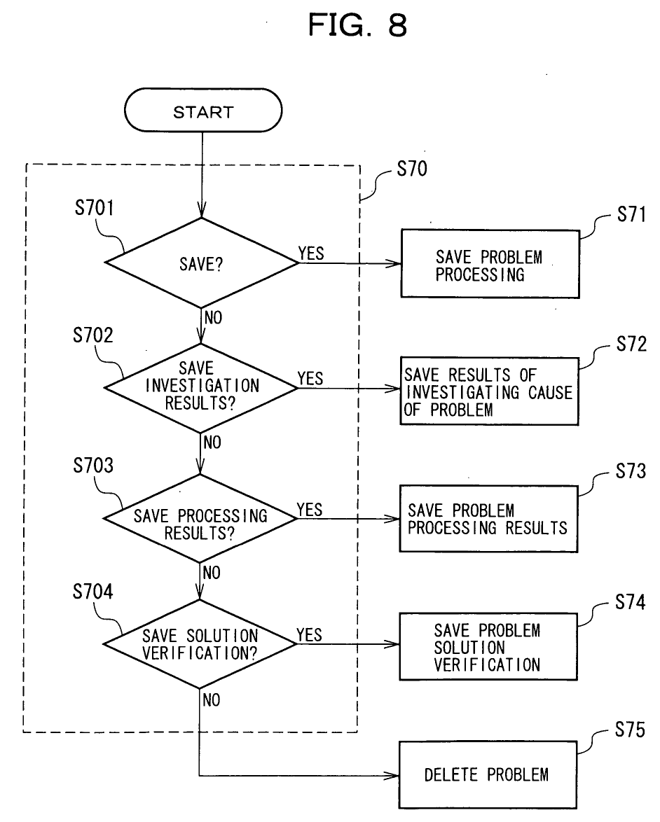

FIG. 8 shows the flow of processing for the case in which the present invention is applied to the control of data with regard to problem processing for software. The control of problem processing for software is a control of the processing conditions for a problem occurring at the stage of software development.

That is to say, a control of situation regarding handling of problem matter.

As shown in FIG. 8S the contents of a processing request input from the information terminal 4 are judged at the step 570 and, based on the result of that judgment, processing is proceeded to one of process steps S71 to S75. If the input processing request is “Saving”, a judgment is made at step S701 that the request is for “Saving”, and the processing is proceeded to step S71. At step S71, problem processing data is input from the information terminal 4, and sent to the information processor 2 via the Internet 5. The information processor 2 saves the problem processing data thus received in the storage apparatus 3.

In the case in which the processing request input from the information terminal 4 is “Save Investigation Results”, at step S701 the judgment result is “No”, and the processing is proceeded to step S702, at which the judgment is made that the request for processing was for “saving of investigation results,” and then the processing is proceeded to step S72. At step S72, the stored number for the problem and the results of investigating the cause are input from the information terminal 4, and the information processor 2 saves the results of the investigation of cause into the storage apparatus 3. The processing for data performed by the information processor 2 is the same as the above-described processing to update data.

In the case in which the processing request input from the information terminal 4 is “Save Processing Results”, a judgment of the processing request is made at step S701, the result thereof being that the processing is proceeded to step S702, at which a further judgment is made, that the result of which is “No”, whereupon the processing is proceeded to step S703. At step S703, the judgment is made that the requested processing is “Save Processing Results”, resulting in the processing being proceeded to step S73. At step S73, the storage number and processing results of the problem are input from the information terminal 4, and the information processor 2 stores the problem processing results for the problem into the storage apparatus 3.

If the request for processing input from the information terminal 4 was for “Save Solution Verification”, the judgement results of steps S701, S702, and S703 are “No”, and the processing is proceeded to step S704. At step S704, the result of the judgment is “Yes”, whereupon the processing is proceeded to step S74, at which the storage number for the problem and a solution verification signal are input from the information terminal 4, and the information processor 2 saves the problem solution verification into the storage apparatus 3. If the request for processing input from the information terminal 4, is “Delete”, the judgement results at all steps from step S701 to step S704 are “No”, and processing is proceeded to the step S75. At step S75 the a storage number of the problem to be deleted and the deletion instruction are input from the information terminal 4, and the information processor 2, based on this deletion instruction, deletes the problem to be deleted from the storage apparatus 3.

As described in detail above, by adopting the above-noted configuration, the present invention can collect from each work location terminal quality data for software jointly developed in a distributed environment via the internet to a control terminal, thereby enabling to make centralized control system to thereby perform to quickly understanding of overall situation regarding the quality control so that quick can be achieved as they arise and an improvement in the quality of overall software can also be attained.

Additionally, because it is possible to monitor the overall quality control condition from each terminal in the distributed environment, it is possible to prevent the occurrence of duplicated problems, so as to avoid duplicated effort and loss of works, and to improve the work efficiency.

What is claimed is:

1. A software quality control system controlling the quality of software jointly developed in a distributed environment, said software quality control system comprising:
a control terminal for performing an input of quality data of said developed software and a selection of data processing function;
an information terminal having a communication means and for performing an input of quality data of said developed software and a selection of data processing function;
for inputting software quality data and selecting data processing function;
an information processor for processing data input from information input from said control terminal and said information terminal
a storage apparatus for storing data input from said information processor; and
a data communication network that connects said information terminal and said information processor,
wherein said information processor performs saving of quality data input front said control terminal and said information terminal, and retrieving or analysis of data stored in said storage apparatus, based on conditions input at said information terminal.

2. A software quality control system according to claim 1, wherein quality data input from said control terminal and said information terminal is data indicating software quality or data indicating handling situation for a problem to be treated in said software.

3. A software quality control system according to claim 1, wherein said quality data input from said control terminal and said information terminal is classified in said information processor into either one of items of a system, a joint development working group, key personnel, or control data, and each being stored in said storage apparatus.

4. A software quality control system according to claim 1, wherein said quality data input from said control terminal or said information terminal is data with regard to a scheduled test of developed software or with regard to test results.

5. A software quality control system according to claim 1, wherein said information processor stores a processing program in accordance with a type of analysis for quality data, and which, in response to said type of analysis and analysis conditions input from said information terminal, performs analysis of quality data stored in said storage apparatus and outputs the results of said analysis.

6. A software quality control system according to claim 1, wherein said control terminal and said information terminal comprise Web browsers, which are used to perform to input data and to display data supplied from said information processor.

7. A software quality control system according to claim 1, wherein said data communication network is the Internet.

8. A method for controlling the quality of software jointly developed in a distributed environment, comprising the steps of:
inputting quality data of developed software to a terminal;
classifying said quality data input from said terminal via a data communication network by an information processor into pre-established data types, and storing said data in a storage means;
retrieving data stored in said storage means an information terminal by said information processor in accordance with a retrieving condition as input from said terminal and displaying said retrieved results on said terminal by said information processor; and
analyzing data stored in said storage means by said information processor, in response to a data analysis request input from said terminal, and displaying said analysis results at said information terminal by said information processor.
